(19) United States
(12) Patent Application Publication
(10) Pub. No.: US 2010/0032398 A1
(43) Pub. Date: Feb. 11, 2010

(54) SUCTION COMPENSATION APPARATUS FOR A BABY BOTTLE

(75) Inventors: Armin Struckmeier, Pattensen (DE); Hans Struckmeier, Pattensen (DE); Dipl.-Ing. Hans Scholl, Oerlinghausen (DE)

Correspondence Address: Schwabe Williamson & Wyatt;PACWEST CENTER, SUITE 1900, 1211 SW FIFTH AVENUE, PORTLAND, OR, 97204, US

(73) Assignee: Novatex Gesellschaft mit beschrankter Haftung Gummi-und Plastikwaren, Pattensen (DE)

(21) Appl. No.: 12/477,070

(22) Filed: Jun. 2, 2009

(30) Foreign Application Priority Data
Jun. 10, 2008 (DE) 102008027606.5

(51) Int. Cl. A61J 9/04

(52) U.S. Cl. 215/11.5

(57) ABSTRACT

Proposed is a suction compensation apparatus to enable an easy and non-leaking sucking removal of a potable liquid from a container through an attached nipple. The suction compensation apparatus is placed between the container and the nipple and is threadedly secured to the container by a screw ring forming a threaded connection and said apparatus serves to mitigate suction caused by low pressure in the container.

### CROSS REFERENCE TO RELATED APPLICATIONS

The present application claims international priority under 35 U.S.C. §119 to co-pending German Patent Application No. 102008027606 filed 10 Jun. 2008, entitled “Belütungsvorrichtung für eine Trinkflasche,” the entire content and disclosure of which is hereby incorporated by reference in its entirety.

### BACKGROUND

The invention concerns a suction compensation apparatus to serve a drinking bottle, or a baby bottle, (hereinafter designated as a “container”) in accord with the principal concept of claim 1.

From the disclosures of DE 196 01 198 C1, a like apparatus has been made known, wherein, during a liquid removal by sucking from a container, the so caused increased suction therewithin is mitigated by suction relief compensation.

This disclosed apparatus labors under the disadvantage, that a suction relief passage is designed as a convoluted, small tube of cross-section which is progressively reduced. Such a tubular system tends to become clogged, particularly wherein liquid within the container may coagulate. In such a case, the provided function of compensatory air inflow is limited or even blocked.

Another fault of the described apparatus lies in the difficulty of cleaning and hygienically sterilizing the convoluted small tubing in an air supply disk. Disadvantage is further found in the considerable expense of carrying out reliable cleaning.

DE 198 49 271 A1 discloses a similar apparatus, which provides a hollow-body, slot designed valve arrangement located on the lower terminus of an immersion tube.

The difficulty of this design lies therein, in that the operational slot of the hollow-body valve is given to blockage due to adherently entrained particulate and thus the functionality of suction compensation in the interior of the associated container is diminished. This disadvantage occurs in the case of many other suction compensation measures (not mentioned here) wherein the valve slot is provided as an operational principle. The difficulty is exacerbated if the material for the slot is a membrane.

Another disadvantage in the case of the above stated apparatus is found in the complicated cleaning thereof. Further, a public danger exists, in that the relatively small hollow-body valve, when disassembled, can easily be swallowed by small children.

US 2006/0213859 A1 brings forth an apparatus, wherein pressure compensation is provided during sucking at a nipple.

This design possesses the disadvantage, in that the many individual parts are subject to very difficult cleansing and additionally, manufacture of the resulting product is very expensive.

Additional difficulty lie in that, due of the multiplicity of components, manipulation during assembly for use is not a simple operation.

### SUMMARY

The purpose of the invention is to so improve the suction compensation apparatus of the generic type, that the above stated disadvantages are removed and in that sucking from the container is made easier and without leakage. Beyond this advantage, a simple and reliable hygienic cleaning of the individual parts is to be achieved.

The invention enables the availability of a suction compensation apparatus if, for example, the container is a baby bottle, which permits an easy-going suction with a simultaneous prevention of leakage. The invented apparatus characterizes itself further, in possessing a marked small number of components and has a simple construction, whereby use in service is simple and reliable. Furthermore, the invented apparatus permits a hygienic and problem-free maintenance of parts and protects small children from indiscriminant handling of the individual components thereof. Because of the special design of the individual parts, an economical apparatus has been made available, which allows a simple and safe maintenance of the apparatus.

The extensive design of the apparatus together with other features of the invention lead to advantageous functioning, reliable design and convenient arrangement of the apparatus components, whereby the said easily achieved sucking action is especially improved by a well founded suction compensation within the container.

In a predetermined manner, the design of the apparatus in accord with claims 6 and 8 insures a hygienic, problem-free maintenance of the apparatus and, at the same time, protects small children from traumatic injury and untoward use of individual components of the apparatus.

### BRIEF DESCRIPTION OF THE DRAWINGS

Additional features, advantages and details of the invention are made available, with the aid of the attached drawings, in the following description and explanation of one exemplary apparatus. There is shown in:

FIG. 1 illustrates a container with a suction compensation apparatus rendered in an increased scale,

FIG. 2 is a sectional view of a air supply disk of the suction compensation apparatus,

FIG. 3 is a plan view of the air supply disk in reference to direction A of FIG. 2 in an increased scale,

FIG. 4 is a perspective presentation of the air passage disk in an increased scale,

FIG. 5 is a sectional view of a threaded connection between the baby container and a screw-on ring shown in FIG. 1,

FIG. 6 is a partial sectional view of the air passage disk without the air transport tube in an increased scale,

FIG. 7 is a sectional view of a second design of nipple and container connection, and

FIG. 8 is a sectional view of a third design of nipple and container connection.

### DETAILED DESCRIPTION

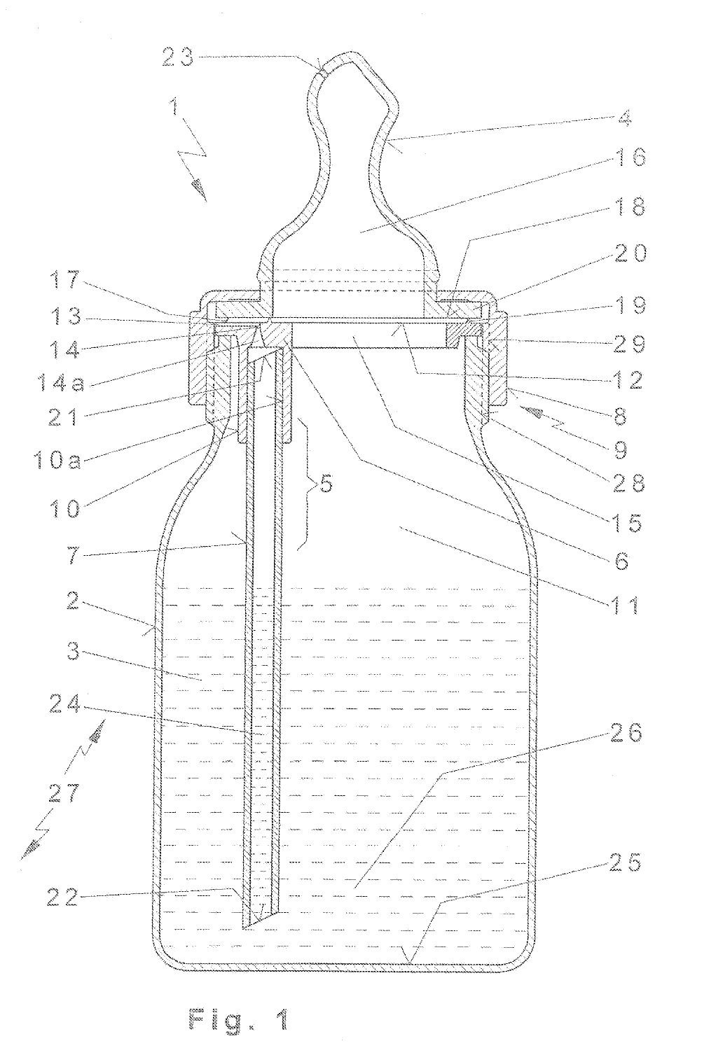

A container 2, to hold a potable liquid 3, possesses a top assembly connection including an external wall threading 28. For example, the stated container could be a feeding bottle for an infant as pictured in FIG. 1. The container 2, together with a nipple 4 and an apparatus 5 for compensation of suction within the container 1 is assembled with an connection ring 8 having an internal threading 29 complementary to the said threading 28, thus forming a functional feeding unit. The external threading 28, integral with the wall of the container 2 in combination with the internal threading 29 form together a special threaded, or screwed connection 9, as demonstrated in FIG. 5. As is evident in FIG. 5, between the external threading 28 of the container and the internal threading 29 of the connection ring 8, a clearance exists, which runs along the contact line of opposed threads, thus providing a free passage for air flow. This clearance and air flow zone between the threads also serves as a necessary means to allow the connection ring 8 to be easily screwed onto the container 2 by the user without jamming.

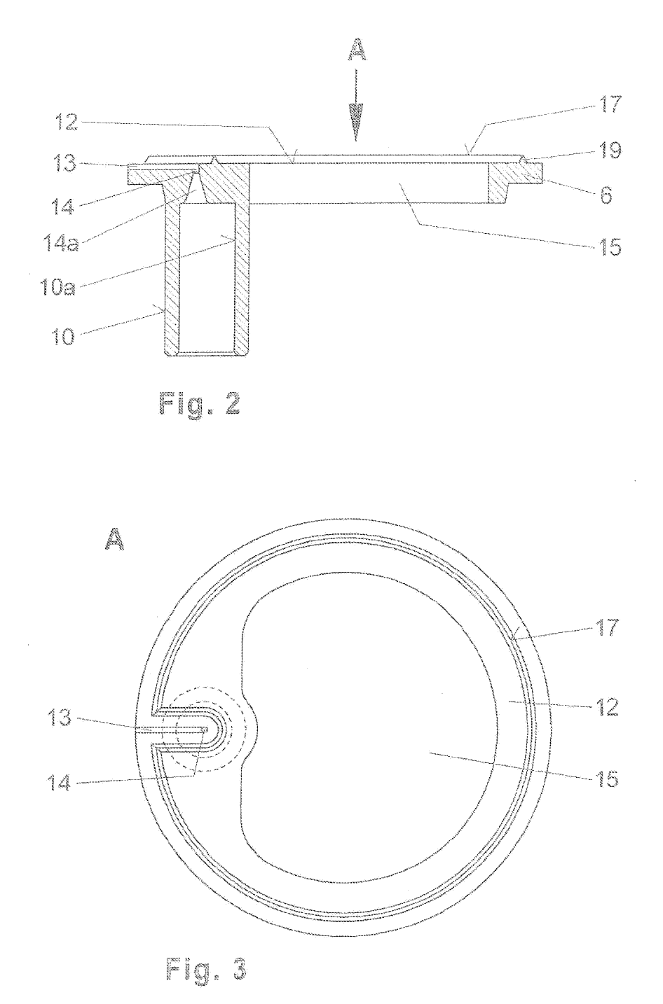

The suction compensation apparatus 5, as shown in FIG. 1, is comprised of two parts, namely first, a closure with air supply disk 6, depicted in FIGS. 2, 3 and second, an air inlet tube 7, which integrally form, in their assembled state, a single unit. This single unit is easily taken apart into its two components for the purpose of cleaning. The air supply disk 6 is sealingly located with its first end face against the rim of the opening of the container 2. The second end face 12, which lies opposite to the first end face forms another sealed contact against a closure surface 18 of a flange 20 of the nipple 4.

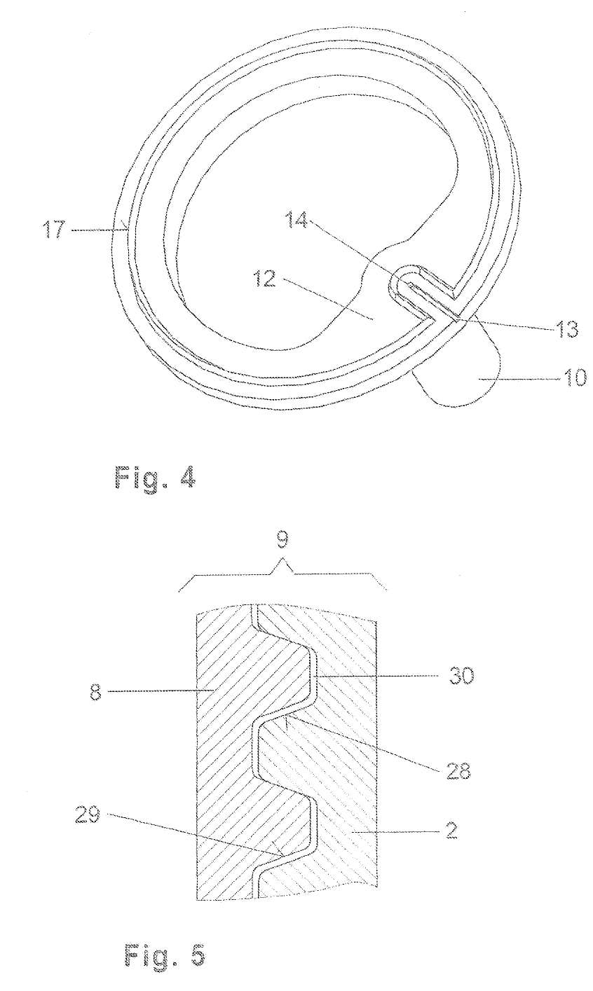

Air supply disk 6, pictured in FIGS. 2, 3, 4, is constructed with a first part being a U-shaped air channel 13, which channel forms a component of the suction compensation apparatus and possesses an opening (horizontal in FIG. 1) through a lower connection surface of flange 18 of the nipple 4. With the aid of connection boring 14a, which, in its progressive downward (as per FIG. 1) course forms an expanding conical cavity in order to subsequently act as a restrictive jet for reverse flow, the air channel 13 becomes flowingly bound to a first end face of a boring 10a, which boring forms a receptor 10 into which an air conduction tube 7 can be inserted with little effort and be retained therein by frictional force.

As will be explained later, an occasion repeatedly arises, wherein unwanted air is to be removed from the container (2). This air removal operation is carried out through a pathway which is detailed as follows: exiting air flow is established through tube 7, then through its connection passage 14 and the restricted orifice of the auxiliary jet 14a, which opens into air passage channel 13. The outgoing air from that point, finds it way through the spaced tooth clearance 30 of the screwed connection 9 to reach free, ambient atmosphere outside the container 2.

Counter to the above, the cross-sectional area for inflow of atmospheric air through channel 13 is continually expanded by the increasing diameter of connection boring 14 and its following conical passage 14a until finally the full opening of tube 7 is attained. Thereby, it becomes possible that the pathway of compensating atmospheric air 27 from the outside consists of the narrow inter-thread passage 30 of the screwed connection 9, the air channel 13, the connection boring 14 with its conical extension 14a and finally the air tube 7. This pathway assures an unrestricted, continually increasing cross-section for flow. Thus, no obstruction impedes the inflow of air into the container 2 in order to compensate for increasing suction therein. Consequently, sucking at the nipple is relieved of an increasing counter suction.

Reversing the situation, the emergence of a normally viscous liquid 3 would block the inflow of compensatory input air. However, because of substantial throttling at the conical connection boring 14, this being designed as a restrictive jet in the outward direction and due to the small air channel 13 and the small clearance 30 between the threads of the connection 9, liquid 3 cannot migrate to the outer air 27. This condition has the result that leakage of potable liquid 3 through this pathway cannot occur.

Further, the air inlet disk 6, as per FIGS. 1, 2, 3, possesses a penetrative opening 15 which enables a free passage of the potable liquid 3 out of the container 2 and into the active nipple space 16.

With this design, all surfaces of the air inlet disk 6 are accessible for an easy and reliable hygienic cleansing.

An additional and advantageous characteristic of the air inlet disk 6 lies in the closed, circumferential sealing washer 17, which fills a circumferential space existing between the second end face 12 up to a circular projection 19, which contacts the under-surface of the nipple flange 18. This circumferential, projecting convexity 19 is sectionally shown in the drawings of FIGS. 1, 2 as a triangular, vertically rising projection 19. By means of this projection 19, the result is achieved, that upon screwing down the container 2 with threaded ring 8 against the circumferential sealing washer 17, the air inlet disk 6 impresses itself easily on the nipple flange 20 and thus assures a prevention of fluid 3 leakage out of the container through the path including the air channel 13 and the clearance 30 between the threads of the connection 9. In this way, no leaking is possible during sucking on the nipple 4.

The upper end face 21 of the air inlet tube 7, as shown in FIG. 1, extends itself to the outer side of the said tube as an inclined surface. In this way the insertion of the air inlet tube 7 into the boring 10a of the air supply disk 6 is facilitated and a reliable inflow of air into the container 2 for compensation is assured. Since the opposite end of the air inlet tube is likewise identically inclined, a reversal of the said tube 7 during mounting is of no consequence.

FIG. 1 depicts a container 1 in an unused, static condition. In this situation the liquid in the container 2 and in the air supply tube 7 stands at equal height. As soon as the container 1 is brought into a usable inclined position with the nipple 4 pointing to a lower level, then the contained potable liquid emerges dropwise from the nipple orifice 23. A continuation of sucking additionally supports this outward flow of the liquid. In this state, the free space 11, normally above the surface of liquid 3 moves into the space 26 formerly occupied by the potable liquid 3, thus proceeding to the bottom 25 of the container 2. As this occurs, upon the outflow of the first liquid 3 droplets out of the nipple orifice 23, a negative pressure is formed within the container 2. When the least negative pressure, i.e. suction, comes into force, then the compensation activity begins. This activity is the unimpeded entrance of compensating air from the outside 27 through the thread clearance 30 of the screwed connection 9, the air channel 13, the connection borings 14 and 14a, until the air finally reaches the air supply tube 7. As a result of the progressive increase of the cross-sections of the air inlet pathway, the atmospheric air flows into the container 2 and exerts its pressure upon the therein contained potable liquid 3 in the original space 26 proximal to the bottom 25 of the container 2.

As soon as the air supply tube 7 is free of potable liquid 3, the low pressure in the said space 26, which is beneath the now elevated bottom 25 of the container 2, is compensated for by the new air pressure. The dropwise liquid flow out of the nipple orifice 23, however, does not cease and each incremental increase of suction, caused by the dropwise removal of liquid, is immediately compensated for by inflow of atmospheric air. Thus, without increasing the intensity of sucking on the nipple 4, in accord with the invention, an easy withdrawal of liquid becomes possible. Because the air supply tube 7 extends itself as far as the bottom 25 of the container 2, the suction compensation device 5 allows, that during the sucking operation, bubbles of compensation air become visible throughout the potable liquid 3.

If the container is no longer in use as a feeding unit and is brought back into its original erect position, then, the potable liquid 3 slowly fills the air supply tube 7 again and a pressurized air cushion acts in turn against the jet-like connection 14, 14a, the air channel 13 and the clearance between the teeth 30 of the screw connection 9. Thus release into to the free outside air 27 is gained.

This post-suction air cushion reaction occurs during the previously mentioned reverse movement of air out of the container and through the throttling of the now diminishing cross-sections of the cited passages. This movement takes place slowly, so that an air cushion can block the air supply tube 7. Accordingly, the potable liquid 3 in the tube 7 can no longer find an exit to the outside, even if container 2 is shaken.

If the air cushion should allow, that the potable liquid 3 in the air supply tube 7, goes so far as the connection boring 14a, 14, when the orifice 23 of the nipple 4 is closed, then cross sectional restrictions obstructing the flow of normally viscous liquid 3 are such that the liquid 3, facing the now diminishing conical passage 14a, cannot flow outward therethrough and thus has no access to the channel 13 and the subsequent clearances 30 of the screwed connection 9 which lead to the outer atmospheric air 27.

An additional variant for suction compensation in a container is of such a nature, that only the air passage disk 6 is an active agent and the air supply tube 7 has been eliminated, allowing compensating air bubbles to migrate directly in the potable liquid 3.

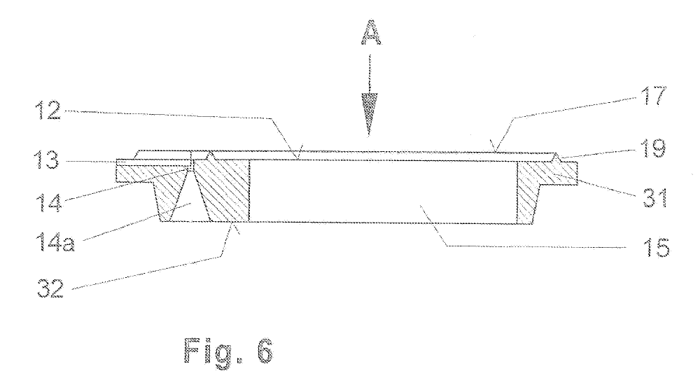

Yet another variant can be shown, wherein the air supply tube 7 is absent. This variant is shown in FIG. 6 and has the advantages of economical manufacture and simple manipulation in its use.

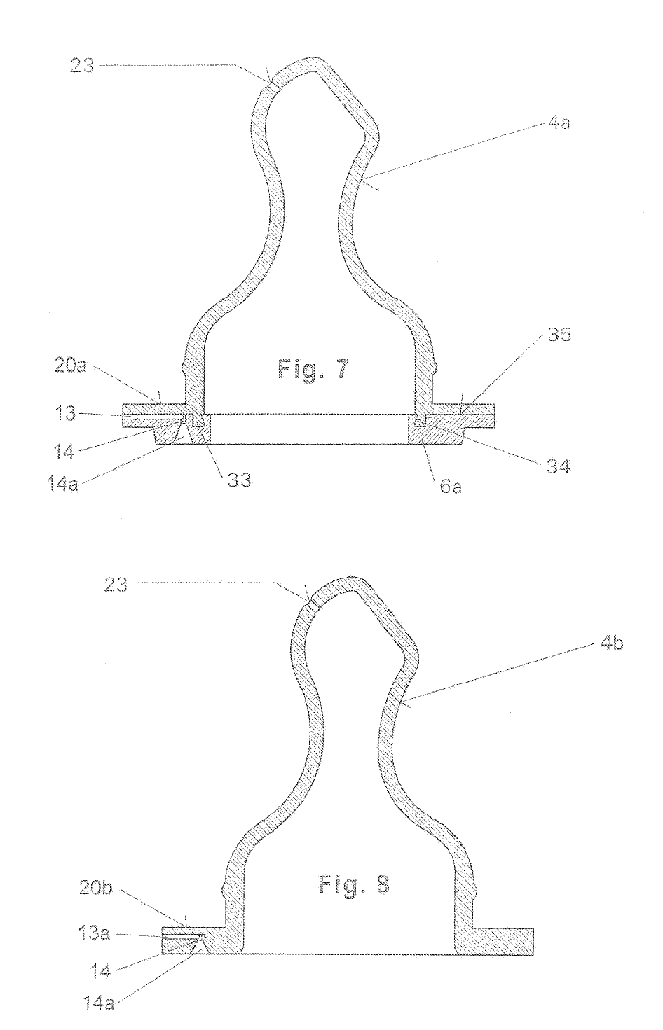

In the second embodiment of the invention as shown in FIG. 7, the air channel 13 in the air passage disk 6a, which channel forms a primary conduit of the suction compensation flow pathway, is designed to be identical to the arrangement shown in FIGS. 1 to 6. However, this channel is formed in such a way, that it possesses the shape of an open groove through the second end face 35. This channel 13 finds a covering by the lower (in FIG. 7) end face surface of nipple flange 20a, which lies in sealing contact against the second end face 35. On the end face of the nipple flange 20a projects a circumferential convexity 33, the cross-sectional thickness of which expands as the projection extends itself from the flange 20a of the nipple 4. This circumferential convexity 33, because of the elastic nature of the nipple 4, seats itself in a complementary circumferential groove 34 of the air supply disk 6a. If the nipple 4a and the air supply disk 6a are manually separated, thus breaking this complementary seating, then the grooved air channel 13 in the second end face 35 of the air supply disk 6 is exposed and can be easily cleaned.

In the case of the version shown in FIG. 8, the nipple 4b and the air supply disk are integrally combined as integral components of the nipple flange 20b. For this purpose, the individual nipple 4a can be injection molded onto the air supply disk. The air supply disk, accordingly, can be of a hard material, and conversely, the nipple 4a can be of a softer material, this being, for instance, silicone. As an alternative, it is possible that the air supply disk and the nipple 4b can be adhesively bonded together. In all of these cases, they then form the unified nipple flange 20b, in the interior of which is found the first section 13a and the thereto connected second sections 14, 14a of the of the suction compensation flow path.

1. A suction compensation apparatus for a container, wherein container is intended for the holding of a potable liquid and wherein container serves as a nipple supplied drinking vessel, wherein, an inlet air compensation system of said container has an air supply disk with a first end face, which can be sealingly contacted with a planar, circumferentially running rim of an opening of container and has a second end face lying perpendicular to the first end face and from which a container nipple extends, the said apparatus also possesses an opening for passage of potable liquid into the nipple holding space and said compensation system possesses a pressure release pathway which connects the interior of the container with ambient atmospheric air, wherein said pathway has a first air channel, which extends itself radially in the direction of the said opening and has in addition, a second passage leading to the first air channel, which second passage opens into the interior of the container, therein characterized, in that the second passage has a passage wherein the cross-section thereof increases itself in the direction of the interior of the container.

2. A suction compensation apparatus in accord with claim 1, therein characterized, in that the passage, wherein the cross-section thereof increases toward the interior of the container, extends itself between the first channel and the first end face.

3. A suction compensation apparatus in accord with claim 1, therein characterized, in that the increasing cross-section of the passage has a conical shape.

4. A suction compensation apparatus in accord with claim 1, therein characterized, in that the second passage possesses an air supply tube which extends itself from the first end face toward the bottom of the container, which bottom is located oppositely to the opening of the container.

5. A suction compensation apparatus in accord with claim 4, therein characterized, in that the air supply tube extends itself to a location proximal to the bottom of the container.

6. A suction compensation apparatus in accord with claim 4, therein characterized, in that the air supply tube is manually insertable and removable and frictionally retained in the area of its axial end within the first end face of the air supply disk, wherein a tube receptor boring is provided.

7. A suction compensation apparatus in accord with claim 4, therein characterized, in that at least one of the two axial ends of the air supply tube is inclined in reference to its longitudinal axis.

8. A suction compensation apparatus in accord with claim 4, therein characterized, in that the material of air supply tube consists of a transparent material.

9. A suction compensation apparatus in accord with claim 1, therein characterized, in that the second end face of the air supply disk can be brought into sealing contact with a reception surface of the nipple of the container.

10. A suction compensation apparatus in accord with claim 9, therein characterized, in that the second end face possesses a closed, circumferential projection on the contact surface impacted by the nipple, with the circumferential exclusion of a segment which contains the first passage of the suction compensation system.

11. A suction compensation apparatus in accord with claim 10, therein characterized, in that the cross-section of the circumferential projection widens increasingly toward the free rim of the second endface.

12. A suction compensation apparatus in accord with claim 9, therein characterized in that the first passage of the pressure compensation flow path is a groove placed in the air supply disk, which opens toward the second end face which is in sealing contact with the receiving surface of the container nipple.

13. A suction compensation apparatus in accord with claim 9, therein characterized, in that mutual, bidirectionally releasable, frictionally secured, adherent complementary attachment elements are constructed on the connecting surface of the container nipple and on the second end face of the air supply disk.

14. A suction compensation apparatus in accord with claim 13, therein characterized, in that the attachment element of the contact surface consists of a circumferential ring projection, which increases in thickness toward its free rim and the attachment element of the air supply disk is a thereto complementary circumferential groove.

15. A suction compensation apparatus in accord with claim 1, therein characterized, in that the first passage of the suction compensation flow path comprises a closed channel within the air supply disk.

16. A container with a suction compensation apparatus in accord with claim 1.

17. A container serving as a drinking bottle, in accord with claim 16 with an external, wall located screw threading which borders on the opening of said container, having a threaded ring with internal threading opposed and complementary to external threading, by means of which thread engagement the air supply disk, is brought into closing contact with the container opening, therein characterized, in that the first passage of the pressure compensation pathway opens into the interior space of the container through the air-flow clearance through clearance between the threading and the counter threading in the screwed closure.
